(19) United States
(12) Patent Application Publication
(10) Pub. No.: US 2010/0299361 A1
(43) Pub. Date: Nov. 25, 2010

(54) DEVICE AND A METHOD FOR PREDICTING COMMENTS ASSOCIATED WITH A PRODUCT

(75) Inventors: Stephane Geney, Lannion (FR); Franck Meyer, Lannion (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/782,396

(22) Filed: May 18, 2010

(30) Foreign Application Priority Data
May 19, 2009 (FR) 09 53316

(51) Int. Cl. G06F 17/30

(52) U.S. Cl. 707/780; 707/E17.014

(57) ABSTRACT

A method is provided for predicting comments on a given product from a predetermined list of products information, which is displayed on a display screen for a given user having a stored user profile describing the preferences of the user for at least a portion of the product list. The method includes: determining from a user profile database a set of user profiles close to the profile of the given user, obtaining a list of comments on the given product posted by users corresponding to the profiles of the determined set, and sending to the display screen a predetermined number of comments from the list obtained to be displayed in association with information on the given product. Also, a comment prediction device is provided, which uses the method as described and a prediction system.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to a method of predicting comments associated with a product as a function of user preferences.

For example, in applications for on-line sale of goods or services, a user looking at a product before purchasing it is interested in any comments that other users may have posted on the product in question.

### BACKGROUND OF THE DISCLOSURE

If the number of users is high, the number of comments available for the same product can also be high. Consulting all the comments linked to a product then becomes laborious for the user.

However, there are systems, notably that found at present on the on-line sales Internet site www.Amazon.com, where comments on a particular product are selected in order to display only a small number of them to the user.

To be able to effect this selection, a comment associated with a product is first rated by users who must post a relevance rating for the comment associated with the product.

If the comment in question has sufficient ratings, it is then possible to file it with different comments on the same product and to select the comments deemed most relevant by other users.

This is not the optimum selection, however. It requires a prior phase of entering relevance ratings associated with each of the comments before it is possible to make a selection. Moreover, the selection of comments to be displayed for a particular product does not necessarily match what the user really feels about the product. The displayed comments therefore do not necessarily correspond to what the user would have posted by way of a comment on the product.

### SUMMARY

An aspect of the disclosure relates to a method of predicting comments on a given product from a predetermined list of products information, which is displayed on a display screen for a given user that has a stored user profile describing the preferences of the user for at least a portion of the product list. The method includes the following steps:

determining from a user profile database a set of user profiles close to the profile of the given user;

obtaining a list of comments on said given product posted by users corresponding to the profiles of the determined set; and

sending to the display screen a predetermined number of comments from the list obtained to be displayed in association with information on the given product.

Thus an example of the method makes it possible to provide the user with one or more predicted comments that correspond to what they would have thought of the product.

The user therefore has immediate and concrete information on how much the product might be of interest to them. They are not obliged to consult a plurality of comments to find the one likely to match theirs. This saves them considerable time.

The various features of the present disclosure referred to below may be combined with the above-mentioned features independently or in combination.

In one implementation, determining a set of user profiles close to the profile of the given user includes the following steps:

predicting an interest rating for the given product based on the profile of the given user; and

determining a set of users as a function of a criterion of matching between the predicted interest rating and interest ratings for the given product from users whose profiles are stored in the user profile database.

Thus a user who has not posted an interest rating for a product that they are looking at on a display screen, for example, sees on the display a rating predicted as a function of their preferences and predicted comments on the product.

This further reinforces the information as to the interest that the user might have in the product.

In one particular implementation, determining a set of user profiles close to the profile of the given user includes the following steps:

calculating a distance between product vectors representing interest ratings for the products or for the characteristics of products from the predetermined list for users whose profiles are stored in the user database and the product vector of the given user; and

determining a set of users for whom the corresponding distance is below a predetermined threshold.

This provides a simple way to compare different user profiles.

This feature can be applied if the user profile includes an overall interest rating for each product or interest ratings on product features or descriptors, the vectors produced then being descriptor vectors.

The comments displayed for a given product correspond to the comments of users who have similar or even identical interest ratings for the product as the user concerned. The comments are therefore in sympathy with what the user might think.

In one implementation, the product information displayed is a page describing the product.

When consulting a product page, for example one for a DVD of a film, the user can at the same time see comments on the film likely to match their own opinion.

In another implementation, the product information displayed forms part of a list of products recommended to the user.

At the same time as a recommendation of products that might be of interest to the user, the user can read the associated comments to obtain an immediate opinion as to the interest of the product.

In a further implementation, the product information displayed is an advertisement for the product.

Thus the user can tell, from the comments associated with the advertisement, whether the target product might be of interest to them without having to take any further action.

Thus many other forms of product information can be displayed.

In one particular implementation, an interest rating for a given product is obtained via a user interface by acting on an interest indicator displayed on a page describing the product.

This amounts to updating user profiles explicitly because they then include the real rating that the user has given for a product.

In another particular implementation, an interest rating for a given product is estimated as a function of the user's actions regarding displayed product information.

Thus it is possible to estimate the rating that a user would have given to a product taking account of the user's actions with regard to the product information they obtain. For example, buying the product, looking up details of the product or quitting a product page indicate the user's interest in the product.

The present disclosure also provides a device for predicting comments on a given product from a predetermined list of products for a given user having a stored user profile describing the preferences of the user for at least a portion of the product list. The device includes:

means for determining from a user profile database a set of user profiles close to the profile of the given user;

means for obtaining a list of comments posted by users corresponding to the profiles of the set determined for said given product; and

means for sending to a display screen a predetermined number of comments from the list obtained to be displayed in association with information on the given product.

This device can be inserted into a server, typically an application management server for on-line sales, rental, consultation or broadcasting services.

The disclosure further provides a system for predicting comments, including a prediction device as described above and a multimedia terminal including a display screen able to display the predetermined number of comments in association with information on the given product.

The multimedia terminal can be a computer, for example, a multimedia player, a mobile telephone, a TV decoder associated with a television or more generally any multimedia equipment.

An interface suitable for the display screen includes a product information window, a window displaying the predetermined number of comments, and a space dedicated to entry of comments by the user via a user interface.

The disclosure also provides a computer program including code instructions for executing the above method of predicting comments when they are executed by a processor.

### BRIEF DESCRIPTION OF THE DRAWINGS

Other features and advantages become more clearly apparent on reading the following description given by way of non-limiting example only and with reference to the appended drawings, in which:

FIG. 1 shows a comment prediction system including a comment prediction device of one embodiment of the disclosure;

FIG. 2 shows in flowchart form the steps of a comment prediction method of one implementation of the disclosure;

FIG. 3a shows an example of the content of the product database in one embodiment of the disclosure;

FIG. 3b shows an example of the content of the user profile database in one embodiment of the disclosure;

FIG. 3c shows examples of user action ratings stored in the user profile database;

FIG. 4 shows a first example of application of the disclosure, here to recommending products; and

FIG. 5 shows a second example of application of the disclosure, here to consulting product description pages.

### DETAILED DESCRIPTION OF ILLUSTRATIVE EMBODIMENTS

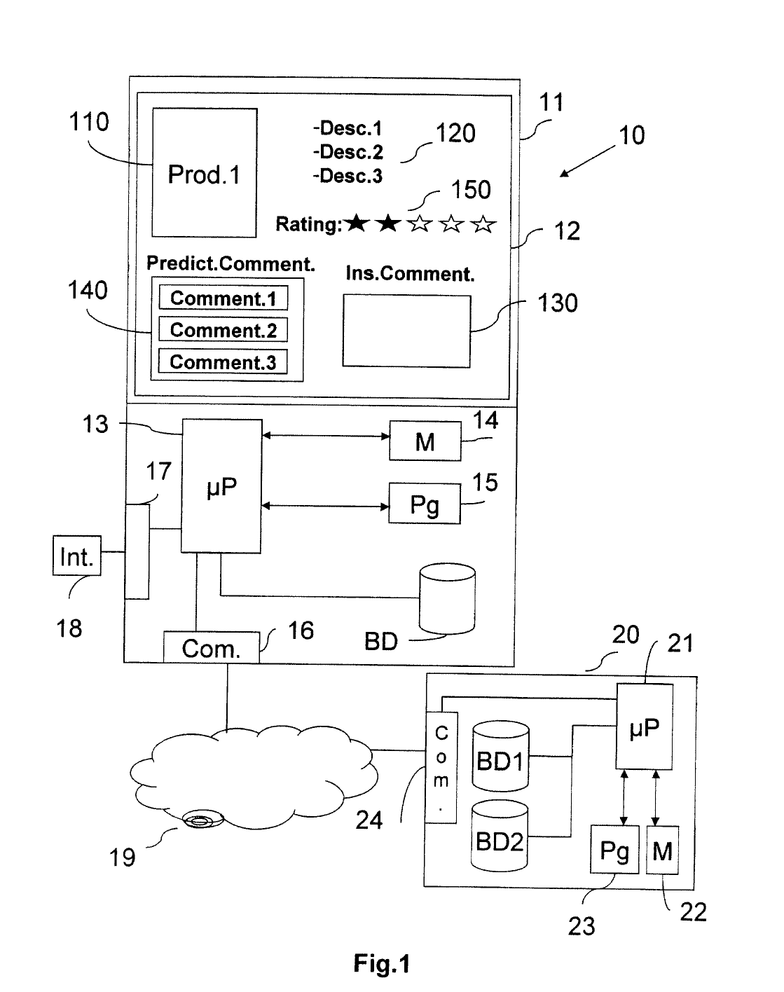

FIG. 1 represents a comment prediction system including a device 20 for predicting comments on a given product forming part of a predetermined list of products, for example a list of products from a catalogue of on-line product sales, multimedia content rental or purchase or any other product for which information may be viewed on a display screen.

This device may typically be incorporated into a computer in an application management server for the predetermined products, for example an on-line sales or multimedia content broadcast server.

A multimedia terminal 10 connected to the prediction server or device via a communications interface 16 and a communications network 19 is able to transfer information on a given user using the terminal and on such data as the user may enter and to display product information from the device 20 on the display screen 11.

This multimedia terminal is a computer, for example, a TV decoder associated with a television, a multimedia player or a communications terminal such as a mobile telephone.

Thus the terminal 10 includes a display screen 11 on which is displayed for example a graphical user interface 12 containing, for example, a description of a particular product Prod. 1. This product is described by displaying a photo 110 of the product and a brief description 120 of the product, for example.

An interest rating 150 for the displayed product may be updated by the user. Here the interest rating is represented by stars that are filled in if the cursor of a user interface is placed over them. The more stars are filled in, the higher the interest of the product is.

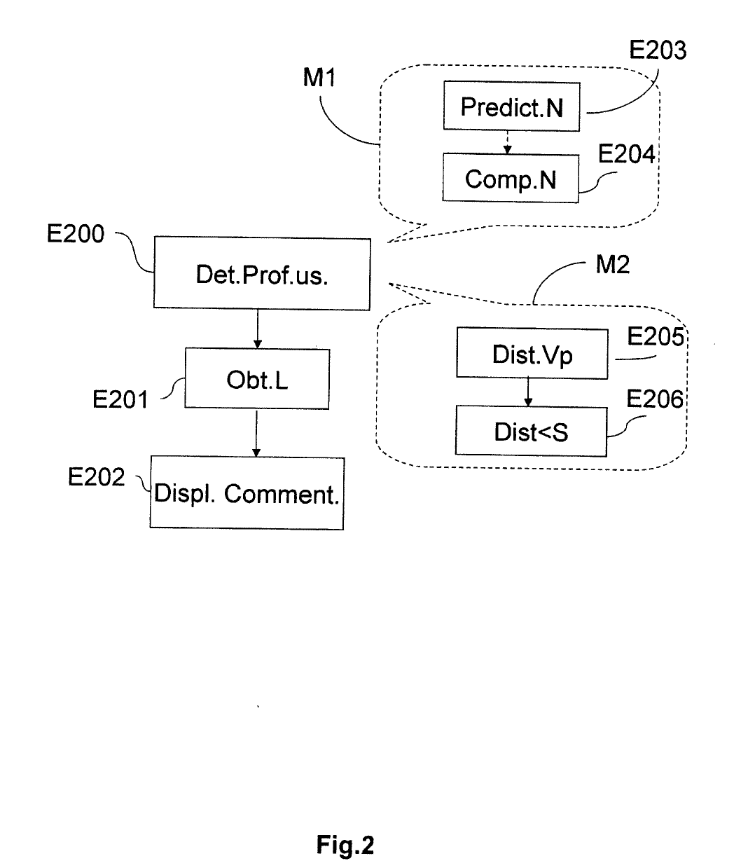

This interest rating displayed to the user may also be a rating that is predicted by the device 20 of the disclosure as described below with reference to FIG. 2.

Here the graphical user interface includes a window containing a plurality of predicted comments that correspond to what the user might think of the product. The comments displayed in this way are selected by means of a comment prediction method to be described with reference to FIG. 2.

The graphical user interface also includes a window 130 in which the user can insert their own comments on the displayed product. Comments inserted in this way are stored in an internal database BD of the device and may be transferred via the network 19 to a product database BD1 hosted by the server or device 20.

The terminal 10 further includes a processor unit 13 provided with a microprocessor and connected to a memory 14. The processor unit is controlled by a computer program for managing the various applications of the terminal.

The processor unit receives instructions from an input module 17 via a user interface 18, for example a computer mouse or any other means enabling the user to select items shown on the display screen. The processor unit therefore receives the interest rating posted by the user or inserted comments on the displayed product, for example.

It may also receive from the interface instructions for actions such as buying the product, going to another display window or any other possible action.

The device includes an internal database BD able to store information on the user and on actions that they may choose to perform and information that they may choose to insert on a product.

This information is then transferred to remote databases on the server 20 accessible by the device 10 via the communications module 16 and the communications network 19.

This information makes it possible to update a product database BD1 listing information on a predetermined number of products and a user profile database BD2 listing users' preferences for the products.

Other types of memory can be envisaged of course, such as removable memory media.

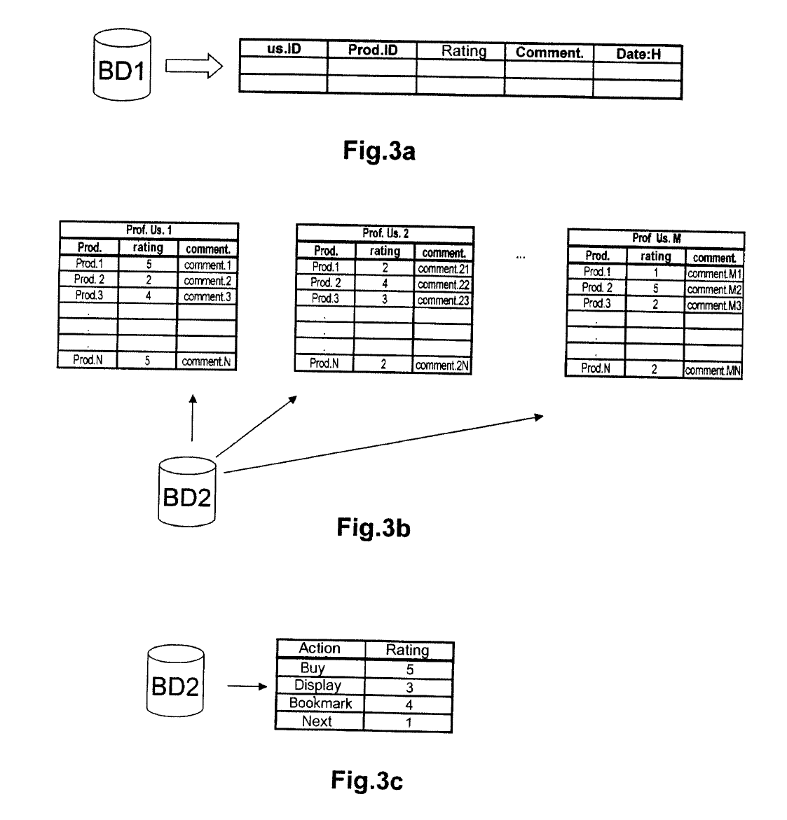

FIGS. 3a, 3b, and 3c represent examples of the contents of these databases.

The device or server 20 hosting the databases BD1 and BD2 includes a processor unit 21 including a microprocessor and connected to a memory 22.

The processor unit is controlled by a computer program 23, in particular to implement the comment prediction method of one implementation of the disclosure described below with reference to FIG. 2.

The computer program includes code instructions for executing the steps of the comment prediction method and in particular the steps of:

determining from a user profile database a set of user profiles close to the profile of the given user;

obtaining a list of comments for said given product posted by users corresponding to the profiles of the determined set; and

sending to a display screen a predetermined number of comments from the list obtained, to be displayed in association with information on the given product.

The computer program may also be stored on a removable or non-removable memory medium readable by a reader or a processor of the server or downloadable into its memory.

The server 20 identifies the user of the terminal 10 using a standard authentication phase that is not described in detail here.

There is a user profile for the authenticated user in the user database BD2. This user profile describes the preferences of the user for at least part of the product list for service provided by the server.

This server also includes means for determining a set of user profiles from the user profile database that are close to the profile of the authenticated user.

The determination of this set of profiles is described in detail below with reference to FIG. 2.

The server 20 includes means for obtaining a list of comments for a given product, notably for the product displayed on the screen of the terminal 10, these comments being obtained from users whose profiles have been determined as being close.

The given product can equally be a product to be recommended to the user by means of a method of recommending products as a function of the user profile.

Finally, the server 20 includes means for sending information to be displayed on the display screen of the terminal 10 via the communications module 24 and the network 19. This information includes a predetermined number of comments from the list previously obtained and information on the product itself, for example the product description page, the product recommendation or simply broadcast content relating to the product.

Thus the user of the terminal 10 may view comments that correspond to their profile at the same time as the product information itself.

FIG. 2 represents the main steps of a method of predicting comments for a given product and a given user executed on a server as described with reference to FIG. 1, for example.

FIG. 2 shows two variants M1 and M2 of the step E200.

The step E200 is a step of determining a set of user profiles close to the profile of the given user authenticated during a first phase of authentication that is not described here.

The user profiles are stored in a user database BD2, one example of the contents of which is described below with reference to FIG. 3b.

In the first variant M1, this step E200 includes a step E203 of predicting an interest rating of the given user for the given product on the basis of the user profile. To this end, the user profile is analyzed to determine interest ratings that the user has already given for other products. Such interest rating prediction is described in a document describing recommendation based on collaborative filtering entitled “Understanding and Improving Automated Collaborative Filtering Systems”, PhD dissertation of Jonathan Lee Herlocker, University of Minnesota, 2000, for example.

A step E204 is then implemented to compare this predicted rating for the given product and the ratings for the same product from users whose profile is stored in the user profile database.

A matching ratings criterion is defined. It may simply require equal ratings or a difference between ratings of one or more units, depending on the maximum rating that a user can give a product.

Interest ratings meeting this matching criterion are retained and determine a set of users whose profile is close to that of the given user.

In the other variant M2, the step E200 includes a step E205 of calculating a distance between product vectors of users whose profiles are stored in the user database. These product vectors represent the interest ratings stored for products listed in the product database BD1.

Alternatively, this product vector may correspond to interest ratings given to product characteristics and not the product overall.

Either way, there is a product vector for each user.

The distance between the product vector of the given user and that of the other users is calculated from a scalar product of the product vectors.

A threshold S is determined to define the maximum authorized distance depending on the type of application implemented on the products.

A step E206 is then performed to compare the calculated distances to the defined threshold S and to select only users corresponding to distances below the threshold. The users selected in this way are therefore users whose profiles are close to the profile of the given user.

The step E200 is followed by a step E201 of obtaining a list L of comments on the given product posted by the users determined in the preceding step.

There is not necessarily a comment associated with each user and each product. This depends on what users have posted during previous consultations of the service.

If there are no comments associated with this list of users, it is possible to revert to determining close profiles to authorize a wider decision threshold, either in the variant M1 by authorizing a greater difference between the ratings or in the variant M2 by raising the threshold S.

A predetermined number of comments from the list L is sent to the terminal 10 in the step E202, to be displayed on the display screen with the corresponding product information. A small number of comments is chosen, for example one to three comments, to reduce the display space and to restrict the amount of information that the user has to read.

In the variant M1, the predicted rating is also sent for display with the product information.

The user therefore obtains immediately an indication of the interest of the product that they are looking at and an opinion that might match their own opinion.

They can therefore decide very quickly what action to take regarding the product.

An example of the data contained in the databases BD1 and BD2 described with reference to FIG. 1 is described below.

FIG. 3a shows a database BD1 containing product data and associated comments.

Here this database is represented in the form of a table listing in a first column, user identifiers (Us.ID), in a second column, product identifiers (Prod.ID), in a third column, interest ratings for the products (Rating), in a fourth column, if necessary, associated comments (Comment), and, optionally, in a fifth column, the date and time (Date:H) the comments were posted.

This database is described here for illustration only and may of course include more product information, for example a plurality of descriptors and interest ratings associated with the descriptors. It can be represented in any form other than a table.

An example of the contents of the user profile database BD2 is described below with reference to FIG. 3b.

Here three tables each defining a user profile are shown (Prof.Us.1, Prof.Us.2, and Prof.Us.M). In each of these tables, a first column lists the products of the service provided by the server. Here this list comprises N products (Prod.1, . . . , Prod.N). A second column associates an interest rating with the corresponding product. Here this rating has a value from 1 to 5 but may obviously take any other type of value or range of values, and in particular negative values.

Here a third column lists comments posted by the user for the corresponding products.

The user profile need not include this comments column. The comments can form part of a database of comments independent of the user profile database. Comments associated with products and users can equally be retrieved from the product database BD1.

Thus here a product vector as used in the variant M2 described with reference to FIG. 2 is, for user 1, the vector V1=(5, 2, 4, . . . , 5), for user 2, the vector V2=(2, 4, 3, . . . , 2), and for user M, the vector VM=(1, 5, 2, . . . , 2).

These user profiles are updated as soon as a user posts a new item such as a new comment or interest rating for a product.

This interest rating for a particular product can be obtained directly following action by the user via their graphical user interface on an interest indicator represented on a page describing the product, as in FIG. 1, for example.

In another implementation this interest rating can be estimated on the basis of possible user actions following on from the display of product information.

A rating for a given type of action is defined in accordance with the table represented in FIG. 3c. Thus in FIG. 3c the rating posted for a buy action is 5, for example. A rating of 3 is posted for a display action, a rating of 4 for a bookmark action (storing the product page in the user's favorites), and a rating of 1 for the action of going to the next product or quitting the display of the content.

These ratings are obviously merely examples. It is equally possible to envisage other rating values and other types of action.

These ratings update the user profiles implicitly.

Thus the user's actions when consulting a product page for example are logged. A rating relating to each action is associated with the product and the corresponding user as a function of the ratings defined in Table 3c. The product vector of the user is defined and the rating for each product in the second column of the user profile is updated.

The implicit updating of the profile is transparent to the user.

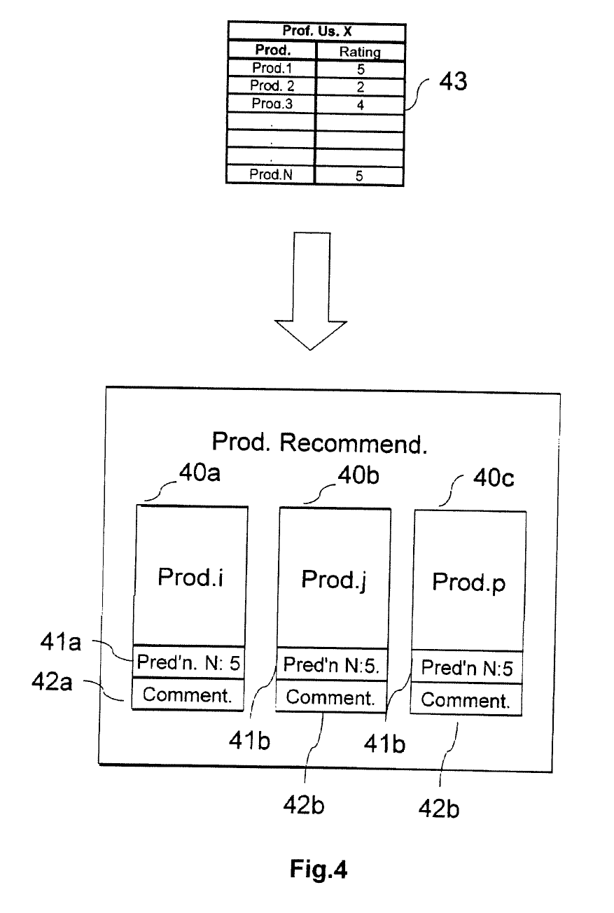

An example of the use of the comment prediction method is described below with reference to FIG. 4.

Products are recommended that correspond to the profile 43 for user X listing interest ratings for N products. One example of use of the product recommendation process based on a user profile is described in the document entitled “Toward the next generation of recommender systems: a survey of the state of the art and possible extensions”, by Gediminas Adomavicius and Alexander Tuzhilin, IEEE Transactions on Knowledge and Data Engineering, vol.17 (6) 734-749, ISSN 1041-4347.

Thus the user views representations 40a, 40b, and 40c of respective products Prod.i, Prod.j, and Prod.p, that correspond to their profile. In addition to the products displayed in this way, the prediction method described with reference to FIG. 2 enables the display in association with this product information of comments that also match the profile of the user. These comments 42a, 42b, and 42c are displayed for the respective products. A single comment corresponding to a user having a profile that is closest to that of the user X is shown here. It is of course possible to display more than one comment.

In the variant M1 described with reference to FIG. 2, predicted ratings 41a, 41b, and 41c can also be displayed in association with the product and the comment. The user is thus informed precisely of the interest they might have in products recommended in this way.

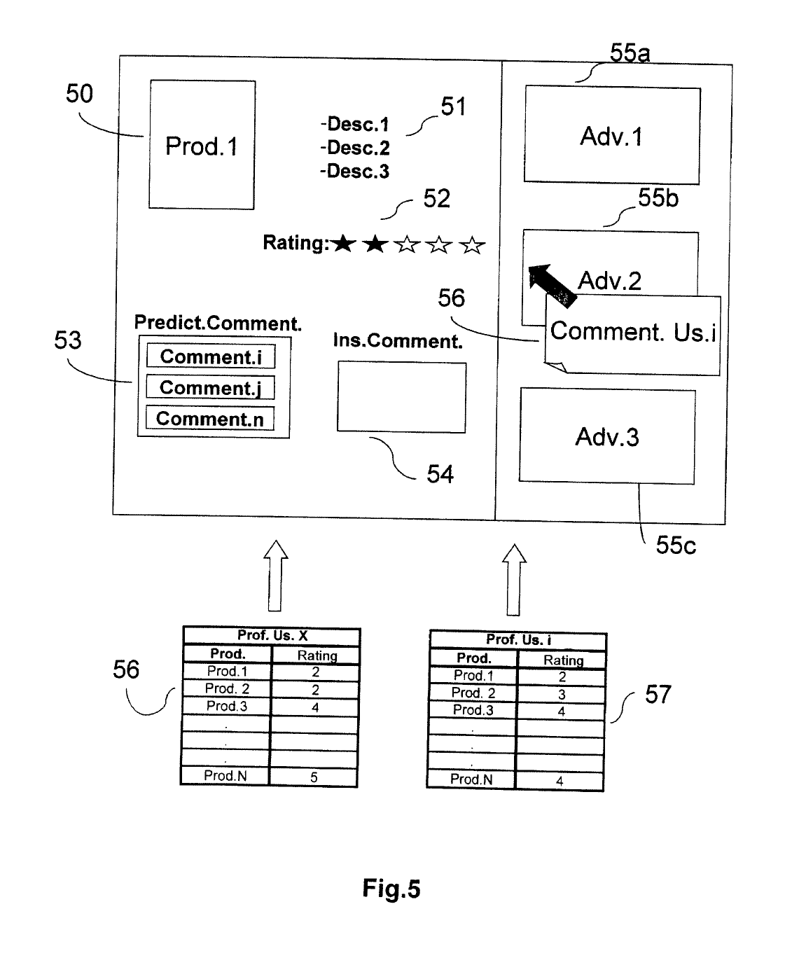

FIG. 5 shows a graphical user interface that can be displayed on the screen of the terminal 10 and described with reference to FIG. 1 in another example of application of the disclosure.

This interface includes a representation 50 of a product, here Prod.1, and annotations 51 describing the product. A rating 52 of the product is displayed either by rating prediction as described with reference to FIG. 2 or by configuration by the user.

Comments predicted by the prediction method described with reference to FIG. 2 are also displayed. The comments displayed here are those of the users i, j, and n, who therefore have user profiles close to the profile of the user X consulting this product page.

The profiles 56 and 57 of the users X and i are represented in FIG. 5.

In the right-hand portion of the graphical user interface, a window displays advertisements (Pub.1, Pub.2, and Pub.3) 55a, 55b, and 55c, respectively. These advertisements are preferably related to the displayed product Prod.1 and can be advertisements recommended to the user X by a known recommendation method.

By clicking on the representation 55b of the advertisement 2 on their user interface, the user X sees a comment Comment.Us.i. This comment is that of a user i who has given their opinion on this advertisement and whose user profile matches that of the user X. When the profiles of the user X and the user i are compared, it can be seen that the displayed product 1 has been given the same rating by both users.

The comment relating to the displayed advertisement is selected by the comment prediction method described with reference to FIG. 2 for products including the target products of the advertisements.

In summary, there is often a desire, such as when consulting a product page or when viewing or listening to a content, to obtain a prediction of the interest of the product or content in question. A comment on the product such as the user would have made then gives the user an immediate indication of the action they might choose with regard to the product. An illustrative example of the present disclosure, as described above, improves on this situation.

Many applications of the disclosure described above may be envisaged. The examples described above are not limiting on the invention and give only a hint of the types of application that are possible. Changes may therefore be made without departing from the scope of the disclosure and/or the appended claims.

What is claimed is:

1. A method of predicting comments on a given product from a predetermined list of products information, which is displayed on a display screen for a given user that has a stored user profile describing preferences of the user for at least a portion of the product list, the method including the following steps:
determining from a user profile database a set of user profiles close to the profile of the given user;
obtaining a list of comments on said given product posted by users corresponding to the profiles of the determined set; and
sending to the display screen a predetermined number of comments from the list obtained to be displayed in association with information on the given product.

2. The method according to claim 1, wherein determining a set of user profiles close to the profile of the given user includes the following steps:
predicting an interest rating for the given product based on the profile of the given user; and
determining a set of users as a function of a criterion of matching between the predicted interest rating and interest ratings for the given product from users whose profiles are stored in the user profile database.

3. The method according to claim 1, wherein determining a set of user profiles close to the profile of the given user includes the following steps:
calculating a distance between product vectors representing interest ratings for the products or for characteristics of products from the predetermined list for users whose profiles are stored in the user database and the product vector of the given user; and
determining a set of users for whom the corresponding distance is below a predetermined threshold.

4. The method according to claim 1, the displayed product information being a page describing the product.

5. The method according to claim 1, the displayed product information being part of a list of products recommended to the user.

6. The method according to claim 1, the displayed product information being an advertisement for the product.

7. The method according to claim 2, an interest rating for a given product being obtained by a user interface acting on an interest indicator displayed on a page describing the product.

8. The method according to claim 2, an interest rating for a given product being estimated as a function of actions of the user regarding displayed product information.

9. A device for predicting comments on a given product from a predetermined list of products for a given user having a stored user profile describing preferences of the user for at least a portion of the product list, wherein the device includes:
means for determining from a user profile database a set of user profiles close to the profile of the given user;
means for obtaining a list of comments posted by users corresponding to the profiles of the set determined for said given product; and
means for sending to a display screen a predetermined number of comments from the list obtained to be displayed in association with information on the given product.

10. A system for predicting comments, including the device according to claim 9 and a multimedia terminal including a display screen able to display the predetermined number of comments in association with information on the given product.

11. The system according to claim 10, the multimedia terminal including a graphical user interface displayed on a display screen including a window of product information and a window displaying the predetermined number of comments together with a space dedicated to entry of comments by the user via a user interface.

12. A computer program including code instructions for executing, when the instructions are executed by a processor, a method of predicting comments on a given product from a predetermined list of products information, which is displayed on a display screen for a given user that has a stored user profile describing preferences of the user for at least a portion of the product list, the method including the following steps:
determining from a user profile database a set of user profiles close to the profile of the given user;
obtaining a list of comments on said given product posted by users corresponding to the profiles of the determined set; and
sending to the display screen a predetermined number of comments from the list obtained to be displayed in association with information on the given product.
